(19) United States
(12) Patent Application Publication
(10) Pub. No.: US 2024/0219002 A1
(43) Pub. Date: Jul. 4, 2024

(54) Rig Lighting

(71) Applicant: Precision Drilling Corporation, Calgary (CA)

(72) Inventors: Michael Nel, Calgary (CA); Kevin Dewar, Calgary (CA); Steve Kastelic, Calgary (CA)

(73) Assignee: Precision Drilling Corporation, Calgary (CA)

(21) Appl. No.: 18/402,427

(22) Filed: Jan. 2, 2024

Related U.S. Application Data
(60) Provisional application No. 63/478,228, filed on Jan. 3, 2023.

(51) Int. Cl. F21V 13/04; E21B 41/00; F21V 5/04; F21V 7/00

(52) U.S. Cl. CPC F21V 13/04; E21B 41/00; F21V 5/045; F21V 5/048; F21V 7/0066; F21W 2131/402

(57) ABSTRACT

The current invention utilizes a light module mounted at some distance below the crown of a rig to reduce the heat reaching the walkway. Additionally, the light module is constructed of a light source such as an LED, a reflector, a shroud, and a lens that together operate to constrain the emitted light to the rig site. Preferably the light source emits a cool blue white light of at least 4500° Kelvin and more preferably at 5200° Kelvin.

### CROSS REFERENCE TO RELATED APPLICATIONS

This is a non-provisional of U.S. Provisional Patent Application Ser. No. 63/478,228, filed Jan. 3, 2023, to which priority is claimed, and which is incorporated herein by reference.

### BACKGROUND

It is necessary to operate around the clock when a rig is operating to drill/service an oil and gas well. The necessity arises due to the high hourly expenses that are involved in providing the equipment on site and working around the lease including remote offices, pipe rack areas, and peripheral equipment. Additionally, around-the-clock operations are required due to the downhole conditions when drilling/servicing a well. For instance well mud is a mixture of a fluid, various chemicals, and various minerals in order to achieve a particular viscosity of the fluid. The viscosity is usually required so that the well mud when circulated downhole can minimize corrosion of the downhole equipment, lubricate the wellbore, and circulate out the bits of rock that the drill bit removes. In order to maintain a particular viscosity the well mud must be constantly circulated. If drilling/servicing were to cease and the circulation pumps turned off the heavier particles in the well mud would precipitate out towards the bottom of the well effectively cementing the drill string in place.

Due to the requirement of operating at night, lights are required. In the past generators with lights on a mast were brought to the well site. More recently lights have been added to the crown of a drilling/servicing rig. The crown of the drilling/servicing rig is the fixed set of pulleys or sheaves located at the top of the derrick or mast, over which the drilling/servicing line or cable is threaded for hoisting hookload. More generally, the crown of the drilling/servicing rig includes a walk around deck with handrails to allow workers to maintain the rig equipment, including the sheaves and pulleys. The bottom of this crown structure is typically referred to as a water table, and it is common for it to be either welded or bolted/pinned to the derrick, or mast structure.

Lights have been added to the crown of the rig due to the case with which the crown may be reached. Usually there is a ladder directly to the crown. Unfortunately, attaching high intensity lights to the crown is not always possible, as the crown is very crowded with sheaves, pulleys, cables, and peripheral equipment such as fall arrest equip, handrails, utilities, etc that must be located on the crown. Also, having high intensity lighting on the crown can add complexity when changing out the crown frame, water table, or sheaves. Further, some types of lights bring an excessive heat load to the crown making it difficult for workers to maintain the equipment on the crown when the lighting is on. Additionally, lighting attached to the higher elevated crown frame of the rig can significantly contribute to an increase in local light pollution in any area in which it is deployed.

### SUMMARY

In an effort to overcome the current limitations and issues related to deploying lighting on a drilling/servicing rig it is envisioned that the lights for wellsite area illumination are mounted on the drilling/servicing rig below the lower deck of the crown and more preferably 1-10 feet below the water table in order to provide for heat dissipation and to reduce light pollution. Additionally, in many instances the structure above the water table, the crown frame, is removable, and commonly the entire crown frame is replaced for maintenance. Mounting the lighting system to the derrick or drilling/service mast provides a secure, long-term solution to wellsite location illumination. Therefore, mounting the lighting system onto the derrick, or mast structure is preferred.

Light pollution is becoming endemic. In an effort to reduce the light pollution on current drilling/servicing rigs, directional lighting is provided. In some instances, the lighting may be directed by reflectors. In other instances, the lighting may be shrouded to curtail light leaking outside of the drilling/servicing rig footprint, the wellsite area. In some instances, the lighting may be directed by a lens or multiple lens. Each of these methods may be used singly or in conjunction with one another to provide the best wellsite area illumination or lighting coverage across peripheral equipment work areas while minimizing the light footprint beyond the wellsite area.

Finally, it has been found that people work best in a cool white, shaded towards blue, light. Generally, this cool white light is associated with a color temperature of about 4500 K and up, most preferably about 5200 K. Therefore, it is an embodiment of this invention to provide a directionally focus light at about 5200 K below the water table and separate from the crown of the drilling/servicing rig.

### BRIEF DESCRIPTION OF THE DRAWINGS

FIG. 1 depicts a drilling/servicing rig with an embodiment of the current invention illuminating a well site.

FIG. 2 depicts the lights illuminating a rig site.

FIG. 3 is a side view of an embodiment of a light assembly.

FIG. 4 is a side view of a second embodiment of a light assembly.

FIG. 5 is a side view of a third embodiment of a light system.

FIG. 6 is a bottom view of the light assembly in FIG. 3.

### DETAILED DESCRIPTION

The description that follows includes exemplary apparatus, methods, techniques, or instruction sequences that embody techniques of the inventive subject matter. However, it is understood that the described embodiments may be practiced without these specific details.

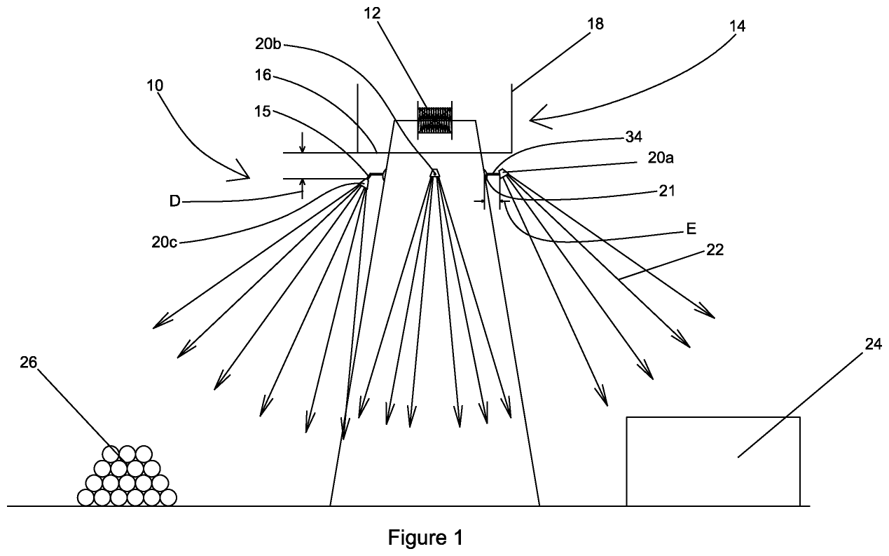

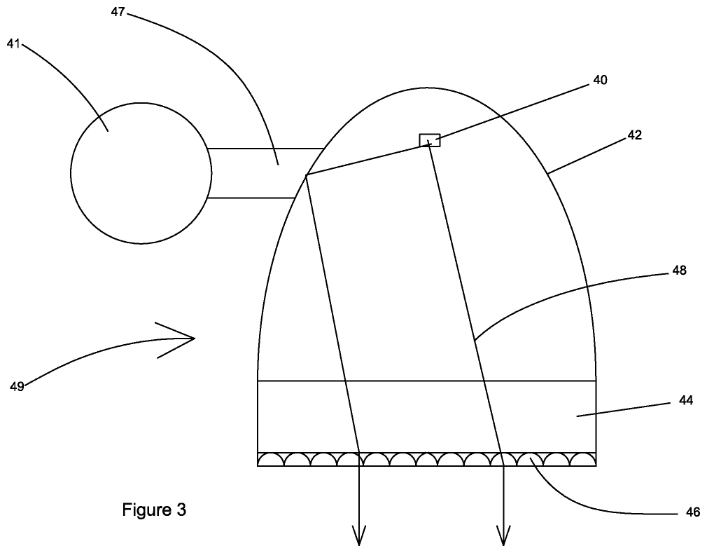

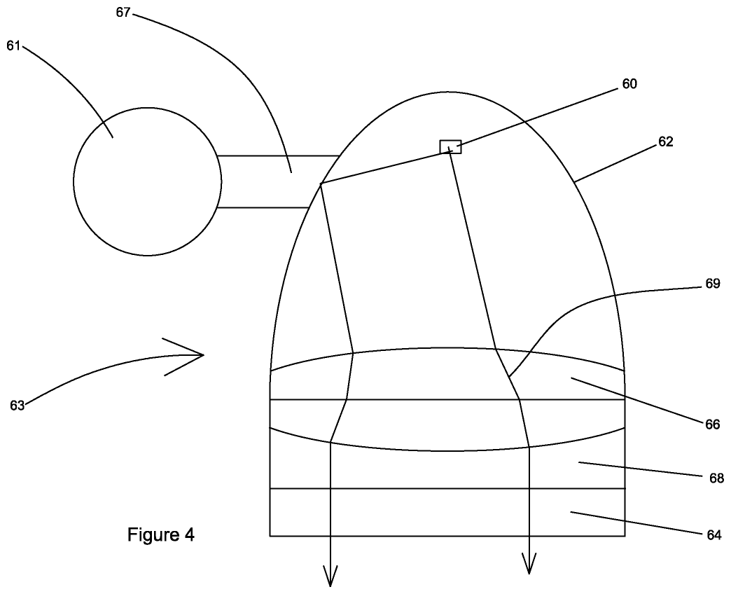

FIG. 1 depicts a drilling/servicing rig 10. The drilling/servicing rig 10 has a crown 14. The crown 14 includes a set of sheaves or pulleys 12, a walkway on the upper side of water table 16, and handrail 18. In an embodiment of the present invention the drilling/servicing rig 10 includes a set of lights 20a, 20b, and 20c. The lights 20a, 20b, and 20c are installed at some distance D below the water table 16. Generally, the distance D is between 1 and 10 feet below the water table 16 but is preferably about 6 feet below the water table and more preferably about 10 feet below the water table 16. Each of the lights 20a, 20b, and 20c generally include a light emitting diode (LED) that provides a light wavelength typically associated with cool white light. Cool white light typically has a temperature greater than about 4500° Kelvin and most preferably at about 5200° Kelvin. While an LED is preferred due to the LED's higher power efficiency, greater light coherence to the preferred light wavelength, and reduced heat output when compared to other light sources such as incandescent or even florescent lights, other light sources may be used. If other light sources are used accommodations, such as second extension 15, may be required to increase the distance D below the water table 16 of crown 14 as well as additional lights may be required in order to provide a sufficient light output. Each of the lights 20a, 20b, and 20c may also include one or more of a directional element such as a shroud, a reflector, or a lens, as is more fully described in FIGS. 3 and 4. Preferably, each of the lights 20a, 20b, and 20c are mounted on an extension 34 some distance E from the drilling/servicing rig 10. Each extension 34 may be attached to the rig using an intermediate mount 21. The intermediate mount 21 may be attached to the rig using magnets, bolts, or welded. The directional element of lights 20A, 20B, and 20C emit light 22 at about 5200° Kelvin where the light 22 is limited to the well site where it may illuminate such items as mud tanks 24 or stacked drill pipe 26.

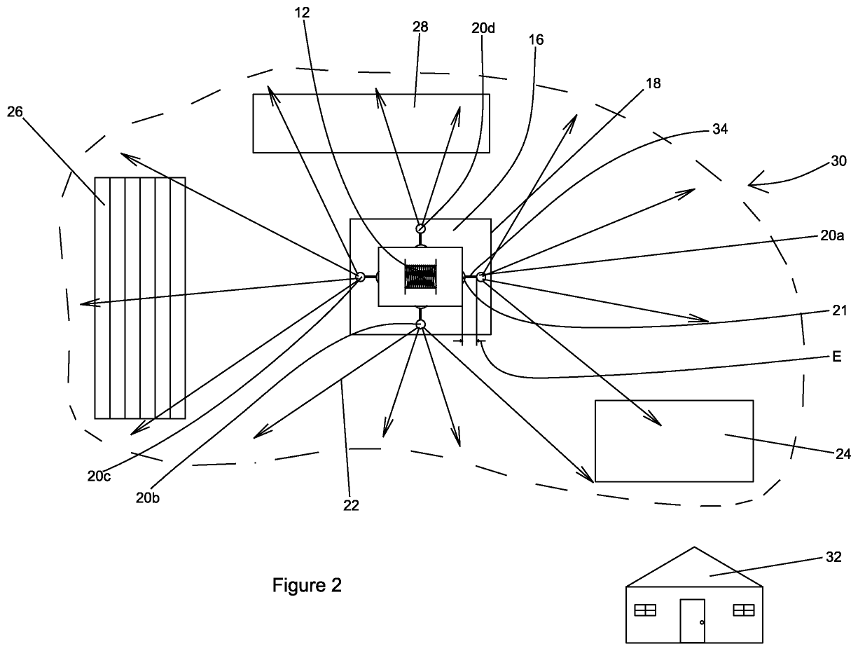

FIG. 2 depicts the lights 20a, 20b, and 20c illuminating the well site area 30. Each of the lights 20a, 20b, and 20c are mounted on drilling/servicing rig 10 below the sheaves or pulleys 12, the water table 16, and handrail 18 of the crown 14. Preferably, each of the lights 20a, 20b, and 20c are mounted on an extension 34 some distance E from the drilling/servicing rig 10. Each extension 34 may be attached to the rig using an intermediate mount 21. The intermediate mount 21 may be attached to the rig using magnets, bolts, or welded. In the embodiment shown the direct light from each of the lights 20a, 20b, and 20c is limited to the rig site where such items as the mud tanks 24, the drill pipe 26, and the control trailer 28 are located. Off-site items such as nearby homes 32 are not illuminated by the direct light from each of the lights 20a, 20b, and 20c.

FIG. 3 is a side view of an embodiment of a light assembly 49. Light assembly 49 includes an intermediate mount 41, an extension 47, a light source 40, a reflector 42, a shroud 44, and at least one lens 46. In this case light source 40 is a LED emitting light at about 5200 Kelvin. In the embodiment shown in FIG. 3 typically the light source 40 is preferably arranged such that the light 48,4 is emitted towards the lens 46, such as when an LED is utilized. However, it is usually difficult to direct all of the light towards the lens 46, depending upon the light source. Therefore, a reflector 42 is provided to further direct errant light rays towards the lens 46. A shroud 44 is provided to block a portion of the light rays that would otherwise be emitted in an undesired direction. Finally, the lens 46 redirects the light that reaches the lens 46 in the desired direction.

The lens 46 may be placed at the lower end of the shroud 44 as indicated in FIG. 3 or the lens may be placed at the lower end of the reflector 42 such that the lens 46 is between the reflector 42 and the shroud 44. In some embodiments the lens 46 may be placed in virtually any position along the length of the shroud 44. Preferably, the lens 46 is a single Fresnel lens although depending upon the requirements any type of lens for combination of lens may be utilized. A connector 41 is typically provided to connect the light 20a to the extension 34. As shown in FIG. 3 the connector 41 includes a ball for a ball and socket connector where the ball is on the connector 41 and the socket would be on extension 34, or vice versa where the ball could be on extension 34 and socket connector 41. Additionally a welded solid mount directly onto the derrick, or mast structure, with or without adjustments is an equivalent mounting with directional control required for on-site adjustment avoiding light pollution.

FIG. 4 is a side view of a second embodiment of a light assembly 63. The light includes a connector 61, a light source 60, an extension 67, a reflector 62, a shroud 64, a first convex lens 66, and a second concave lens 68. In the embodiment shown, the light source 60 is preferably arranged such that the light is emitted towards the lens 66. The light 69 is at least 4500° Kelvin, but preferably around 5200° Kelvin. Reflector 62 is provided to direct errant light rays 69 towards lens 66 and 68. The lens 66 and 68 redirect the light that reaches the lens 66 and 68 in the desired direction. A shroud 64 is provided to block a portion of the light rays that would otherwise be emitted in an undesired direction. Lens 66 and 68 are depicted within the lower end of the reflector 62, and the concave lens 68 is depicted within the shroud 64. The lens 66 and 68 may be swapped one for the other or additional lens may be added. The lens 66 or 68 may also be placed between the reflector 62 and the shroud 64. In some embodiments a shroud 64 may be omitted.

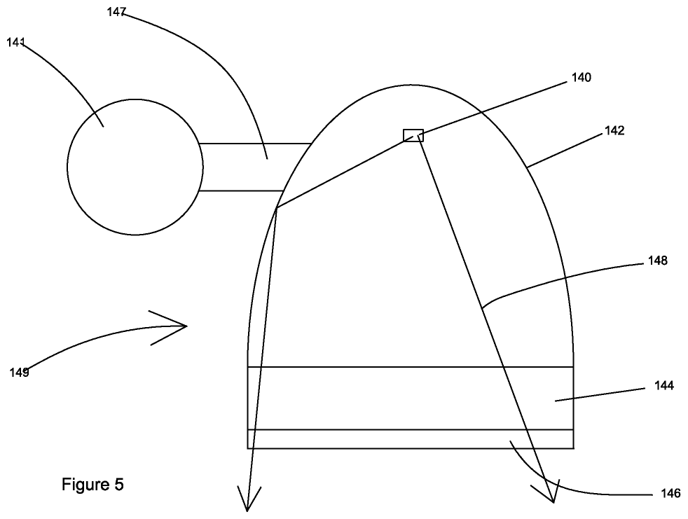

FIG. 5 is a side view of a third embodiment of a light system 169. The light system 169 includes a connector 161, an extension 167, a light source 160, a reflector 162, a shroud 164, and a flat lens 166. In the embodiment shown, light source 160 is preferably arranged such that the light is emitted towards the flat lens 166. The light 169 is at least 4500° Kelvin, but preferably around 5200° Kelvin. A reflector 162 is provided to direct errant light rays 148, towards the flat lens 166. Flat lens 166 prevents contamination from reaching light source 160. A shroud 164 is provided to block a portion of the light rays that would otherwise be emitted in an undesired direction. The flat lens 166 is depicted within the lower end of reflector 162. In some embodiments the shroud 164 may be omitted.

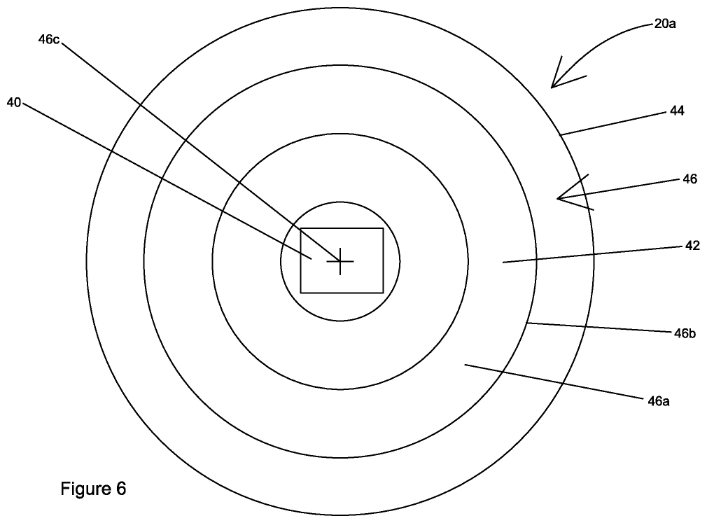

FIG. 6 is a bottom view of the light assembly in FIG. 3. The light 20a includes a light source 40, reflector 42, the shroud 44, and the lens 46. In particular the lens 46 is a Fresnel lens generally having thicker portions 46a and thinner portions 46b arranged concentrically from the center 46c. The thicker portions 46a and the thinner portions 46b are arranged to direct the light emitted from the light source 40 in the direction desired. Generally, lens 46 is clear such that the color of the emitted light 69 is controlled by the LED. If other light sources are used the color of the emitted light 69 may be controlled by tinting the color of the lens 46.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A drilling/servicing rig lighting system comprising:
a drilling/servicing rig having a water table,
a light assembly having a light source, a reflector, and a lens,
an extension,
wherein the extension is attached to the drilling/servicing rig below the water table, further wherein the light assembly is attached to the extension.

2. The drilling/servicing rig lighting system of claim 1, wherein the light source emits light, and
further wherein the light is prevented from illuminating an area outside of a wellsite area.

3. The drilling/servicing rig lighting system of claim 1, wherein the light source is a light emitting diode.

4. The drilling/servicing rig lighting system of claim 1, wherein the light source is an incandescent filament.

5. The drilling/servicing rig lighting system of claim 1, wherein the light source emits light of at least 4500° Kelvin.

6. The drilling/servicing rig lighting system of claim 1, wherein the light source emits light of about 5200° Kelvin.

7. The drilling/servicing rig lighting system of claim 1, wherein the lens is a Fresnel lens.

8. The drilling/servicing rig lighting system of claim 1, wherein the lens is a convex lens.

9. The drilling/servicing rig lighting system of claim 1, wherein the lens is a concave lens.

10. The drilling/servicing rig lighting system of claim 1, wherein the lens is a flat lens.

11. The drilling/servicing rig lighting system of claim 1, wherein the lens is two or more of a Fresnel lens, a convex lens, or a concave lens.

12. The drilling/servicing rig lighting system of claim 1, wherein the extension is attached to the drilling/servicing at least 1 foot below the water table.

13. The drilling/servicing rig lighting system of claim 1, wherein the extension is attached to the drilling/servicing at least 6 feet below the water table.

14. The drilling/servicing rig lighting system of claim 1, wherein the extension is attached to the drilling/servicing at about 10 feet below the water table.

15. The drilling/servicing rig lighting assembly of claim 1, further comprising a shroud, wherein the shroud is attached to the light assembly below the reflector.

16. The drilling/servicing rig lighting assembly of claim 15, wherein the lens is attached to the bottom of the shroud.

17. The drilling/servicing rig lighting assembly of claim 15, wherein the lens is attached to the reflector and the shroud is below the lens.

18. The drilling/servicing rig lighting assembly of claim 15, the lens is attached to the shroud.

19. The drilling/servicing rig lighting system of claim 1, wherein the crown is removable from the drilling/service rig.
